(19) United States
(12) Patent Application Publication
(10) Pub. No.: US 2007/0150498 A1
(43) Pub. Date: Jun. 28, 2007

(54) Social network for distributed content management

(75) Inventors: Mei Li, Pittsburgh, PA (US); Jie Lin, Webster, NY (US)

Correspondence Address: PEPPER HAMILTON LLP, ONE MELLON CENTER, 50TH FLOOR, 500 GRANT STREET, PITTSBURGH, PA, 15219, US

(73) Assignee: Xerox Corporation

(21) Appl. No.: 11/318,135

(22) Filed: Dec. 23, 2005

(51) Int. Cl. G06F 17/30; G06F 7/00; G06F 17/00

(52) U.S. Cl. 707/101; 707/3

(57) ABSTRACT

Methods and systems for managing distributed content are disclosed. Data objects may be received at host nodes. Each data object may be assigned an attribute value for each of one or more attributes that correspond to the data object. A network overlay may be determined based on the attribute values assigned to the plurality of data objects. The network overlay may include a plurality of grid cells. One or more acquaintance links, representing a logical connection between two grid cells, may be generated. Each data object may then be assigned to a grid cell based on at least one attribute value for the data object.

### BACKGROUND

1. 1. Technical Field

The disclosed embodiments generally relate to the field of distributed file management in a computer networking system.

2. Description of the Related Art

Conventional techniques for facilitating shared-file or shared-document environments exist. One type of multi-user software, an example of which is Xerox® GlobalView® software, provides a concept of “shared file drawers.” A shared file drawer is an icon that is present on the screens of a set of users, and the contents of this drawer can be altered by anyone with access to the drawer (although certain documents may be locked as “read-only” documents). However, with GlobalView®, basic access to the drawer is limited to those users who have been given the icon for the drawer by a system administrator. Further, a person with access to a particular drawer will have at least read-only access to every document in the drawer.

A variant on the “shared drawer” concept is the “shared drive” system, which is used by, for example, Novell® network drives. Once again, a set of users must be given access to a particular drive by a system administrator, and for the most part a person with access to the drive has complete access to every file in the drive. Another drawback of the network drive system is that the organization of the drive, from the perspective of each user, is intimately related to the hardware structure of the local area network (LAN) upon which it resides.

Yet another mechanism for enabling document sharing relies on an “Internet” or “website” model. In this model, documents exist via hypertext or other links from a Web page. While certain documents linked to a particular website may have assigned security properties, such as a necessity for a password, this model again has the drawback that an administrator is required to control the entire security apparatus, similar to the system administrator in the above-described systems. The presence of an administrator represents a bottleneck in the usability of such a system, because new documents are typically not made available without permission of the administrator. Further, an administrator must be dedicated on an active, ongoing basis to the management of a website, and hypertext links within the website often become stale, i.e., lead to documents which no longer exist because the administrator does not have ownership of particular documents linked to the website.

As the world moves towards pervasive networking, large amounts of information can be widely distributed within or beyond an organization, such as documents, Web pages, user logs, device logs, scientific results, and the like. Such a distributed information repository is extremely valuable for trend mining, product recommendation, personalization and decision making. The primary challenge for such a repository, as a result of its size, dynamic nature and widespread information, is managing it intelligently to support the above and other tasks. While a centralized system typically cannot scale to large sizes and adapt to rapid information changes, a peer-to-peer (P2P) data management system, built on top of existing host nodes already storing data, is particularly attractive because of its low cost, ease of deployment, scalability, robustness to failure, and adaptability to network and data changes.

One such P2P system has been proposed in Mei Li, et al., “Semantic Small World: An Overlay Network for Peer-to-Peer Search,” 12th IEEE International Conference on Network Protocols at 228-38 (Berlin, Germany 2004). The system organizes computing devices based upon one or more parameters. Devices having similar parameters are more closely related (semantically, not necessarily geographically) to one another. Devices that are closely related may then be grouped into clusters. Clusters communicate via short links (connections with all neighboring clusters) and long links (connections with some distant clusters) to provide connectivity. One problem with such a system with respect to document management is that location information of data objects stored at a particular device is often published to other devices. This can compromise the autonomy of each device.

What is needed is a method for organizing a distributed data management system to enable efficient searching of the files contained therein.

A need exists for a distributed data management system that requires low maintenance, provides high autonomy and provides the ability to search a large number of data objects.

A further need exists for reducing exposure to data objects pertaining to a particular search query.

0 The present disclosure is directed to solving one or more of the above-listed problems.

### SUMMARY

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope.

It must also be noted that as used herein and in the appended claims, the singular forms “a,” “an,” and “the” include plural references unless the context clearly dictates otherwise. Thus, for example, reference to a “data object” is a reference to one or more data objects and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments, the preferred methods, materials, and devices are now described. All publications mentioned herein are incorporated by reference. Nothing herein is to be construed as an admission that the embodiments described herein are not entitled to antedate such disclosure by virtue of prior invention.

A virtual social network for distributed content management and methods of using the same are disclosed herein. Host nodes may be associated with a virtual social identity (or identities) representing locally stored data objects. Host nodes having similar social identities may establish acquaintance links amongst each other. Such acquaintance links may connect data objects and host nodes in a virtual social network. By properly designing the acquaintance links among host nodes, the virtual social network may be a small world network that enables efficient searching and requires low maintenance. In addition, social networks according to embodiments may preserve the autonomy of host nodes and enable complex data objects and arbitrary queries. The described systems and methods may support a variety of tasks, such as personalized content delivery, resource management, device locating and maintenance, distributed data mining and information dissemination.

In an embodiment, a method of managing distributed content may include receiving a plurality of data objects at a plurality of host nodes, assigning, for each data object, an attribute value for each of one or more attributes corresponding to the data object, determining a network overlay, including a plurality of grid cells, based on the attribute values assigned to the plurality of data objects, generating one or more acquaintance links each representing a logical connection between two grid cells, and assigning each data object to a grid cell based on at least one attribute value for the data object.

In an embodiment, a method of performing a search query in a network may include receiving a search query at a first host node in a network. The network may include one or more host nodes, one or more grid cells and one or more acquaintance links. Each host node may include one or more data objects. Each data object may include one or more attributes each having an attribute value. Each grid cell may contain one or more data objects having similar attribute values. The one or more grid cells may be organized based on the attribute values of the corresponding data objects. Each acquaintance link may logically connect two grid cells having only one differing attribute value. The method may further include determining one or more attribute values for the search query, selecting a grid cell associated with a data object on the first host node, comparing the attribute values for the search query with the attribute values for the data objects within the selected grid cell, selecting a new grid cell logically connected to the selected grid cell by an acquaintance link if the attribute values for the search query do not substantially match the attribute values for the data objects within the selected grid cell, repeating the comparing and selecting steps until the attribute values for the search query substantially match the attribute values for the data objects within the selected grid cell, and returning one or more data objects as a search result.

In an embodiment, a system for managing distributed content may include a plurality of host nodes. Each host node may include a processor, a processor-readable storage medium, and a communication link. The processor-readable storage medium may contain one or more programming instructions for performing a method of managing distributed content. The method may include storing a first plurality of data objects, assigning, for each data object, an attribute value for each of one or more attributes corresponding to the data object, receiving attribute values for a second plurality of data objects stored at one or more remote host nodes, determining, via the processor, a network overlay, including a plurality of grid cells, based on the attribute values assigned to the first plurality of data objects and the second plurality of data objects, generating one or more acquaintance links each representing a logical connection between two grid cells via at least one communication link, and assigning each data object to a grid cell based on at least one attribute value for the data object.

### BRIEF DESCRIPTION OF THE DRAWINGS

Aspects, features, benefits and advantages of the embodiments described herein will be apparent with regard to the following description, appended claims and accompanying drawings where:

FIG. 1 depicts an exemplary partitioned virtual social network with acquaintance links for a grid cell according to an embodiment.

FIG. 2 depicts an exemplary method for resolving a search query using a virtual social network according to an embodiment.

FIG. 3 depicts a block diagram of exemplary hardware that contains or implements program instructions for a host node device according to an embodiment.

### DETAILED DESCRIPTION

A host node may be, for example, a computer system in communication with other computer systems via a communications network, such as an intranet, the Internet or the like. As such, a communications network may include a plurality of host nodes.

A host node may contain one or more data objects. A data object may include, for example, a word processor file (e.g., a Microsoft Word® or DOC file), an Adobe Acrobat® file (e.g., a PDF file), a spreadsheet (e.g., a Microsoft Excel® or XLS file), a picture file (e.g., a JPG file), a moving picture file (e.g., an MPG file), a sound file (e.g., an MP3 file), a hypertext file (e.g., an HTML file) and the like. Other file formats or other information, such as device characteristics, stored on a host node may also be considered a data object for the purposes of this disclosure.

In an embodiment, attribute values for one or more attributes may be determined for each data object on each host node. The attributes may include, for example, a file type, a content description (e.g., subject matter to which a data object pertains), a file size, a creation time, a last updated time, and/or the like. The potential attribute values for a particular attribute may be, for example, numerical values and may correspond to values on a dimensional axis pertaining to the attribute. A dimensional axis corresponding to an attribute may be ordered according to any algorithm.

A network overlay corresponding to the data objects may then be generated based on the dimensional axes. The network overlay may seek to adaptively partition the data objects into one or more grid cells. Each grid cell may have a set of attribute values associated with it. In an embodiment, a grid cell may contain a number of data objects. The data objects within a grid cell may have attribute values that correspond to the attribute values associated with the grid cell.

In an embodiment, if the number of data objects in a particular grid cell exceeds a value M, the grid cell may be partitioned into P equal-sized grid cells along a dimensional axis. The dimensional axis may be selected in, for example, a round-robin fashion among the ordered dimensional axes. Other methods of selecting a dimensional axis are also included within the scope of this disclosure. If at least M data objects still reside in a grid cell after partitioning is performed, the grid cell may be further partitioned until no more than M data objects reside in any grid cell. This partitioning may be depicted by a tree structure where the root node represents the entirety of the initial data space and the children of a node represent the resulting smaller subspaces after the node is partitioned.

Partitioned grid cells may be assigned labels as follows: if a given grid cell has a label Cx prior to being partitioned, the resulting partitioned grid cells may be labeled Cx0, Cx1, . . . , Cx(P−1). As such, the data space may be partitioned adaptively according to the attribute distribution of the data objects.

Once the data objects are placed into grid cells, a small world network may be generated based on the network overlay by establishing acquaintance links between grid cells. An acquaintance link may be a logical connection between two grid cells. In an embodiment, each acquaintance link in a network may be established along a dimensional axis (i.e., only one attribute value differs between the two grid cells with which the acquaintance link is associated). Each grid cell may maintain two short acquaintance links to the two neighboring grid cells in each dimension (e.g., in a two-dimensional network, four short acquaintance links may be maintained by grid cells that are not on boundaries). In addition, each grid cell may maintain one or more long acquaintance links with more distant grid cells along dimensional axes with probability 1/d, where d is the distance between grid cells in a particular dimension. Grid cells connected by either short acquaintance links or long acquaintance links may be considered to be “acquaintances” since they have similar values along all other dimensions and are connected. Short acquaintance links may ensure that all grid cells within the small world network are completely interconnected. Long acquaintance links may be used to provide shortcuts between grid cells, and shorten search paths. Additional and/or alternate acquaintance links may be established within the scope of this disclosure.

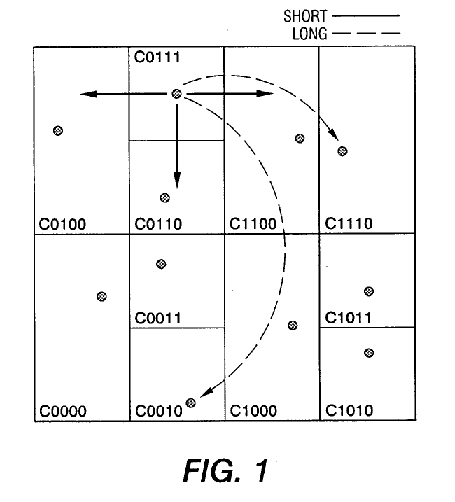

FIG. 1 depicts an exemplary partitioned virtual social network with acquaintance links for a grid cell according to an embodiment. As shown in FIG. 1, the virtual social network has k=2 dimensions. In the depicted embodiment, M may equal 1 and P may equal 2 for purposes of splitting the grid cells. Accordingly, each grid cell may include only one data object and may split a grid cell into two grid cells whenever two or more data objects are present in a particular grid cell. In the disclosed embodiment, a vertical line may represent a first dimension, and a horizontal line may represent a second dimension. In alternate embodiments, the order of the dimensions may differ. When partitioning data objects, the data space may be partitioned along the two dimensions in a round-robin fashion. After partitioning, the depicted grid cell residing at C0111 may maintain, for example, three short acquaintance links to neighboring grid cells (C0100, C1100 and C0110) and two long acquaintance links to distant grid cells (C1110 and C0010), as shown in FIG. 1. Alternate and/or additional acquaintance links may be determined based upon the network overlay, the number of dimensions and the partitioning of the grid cells.

In an embodiment, a first grid cell may only establish an acquaintance link with a second grid cell containing one or more data objects having similar attributes to the one or more data objects in the first grid cell. As such, the proposed network may preserve the autonomy of host nodes by not providing access to data objects other than those that are responsive to a query.

In an embodiment, data objects may be arranged as a coherent framework in which different attributes can be considered individually as a result of the partitioning process. This may enable the system to support both complex data objects and arbitrary queries simultaneously.

In an embodiment, the small world network may perform efficient searches with only a small number of acquaintance links because of the combination of short and long acquaintance links. In this manner, the small world network may provide efficient searching with low overhead.

In an embodiment, a new data object may be added to an existing network. The data object may have attribute values assigned to it based on the dimensional axes of the small world network and the attributes of the data object. The insertion of a new data object may result in a simple insertion of the data object into an existing network overlay, a reorganization of a portion of the network overlay, or a recreation of the entire network overlay. In an embodiment, the determination of whether to insert into, reorganize or recreate the network overlay may be based upon the number of data objects that have been inserted since the last recreation and/or reorganization and/or the number of data objects in the small world network.

If the new data object is inserted into the existing network overlay, the new data object may be placed based on its attribute values. If the new data object is placed in a pre-existing grid cell and the number of data objects within the grid cell exceeds the maximum value, the grid cell may be partitioned as described above. New acquaintance links may be created, removed and/or modified for the partitioned grid cells and/or other grid cells, as required.

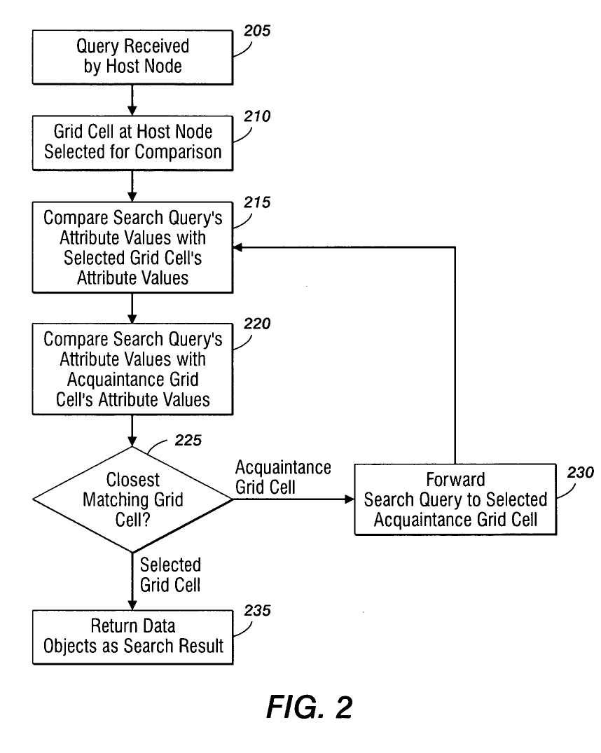

FIG. 2 depicts an exemplary method for resolving a search query using a small virtual social network according to an embodiment. In an embodiment, the virtual social network may support a query process that searches for information among the peers arranged in a small world network. A query may be received 205 by a host node. The query may include and/or may be assigned one or more attribute values corresponding to the attributes used to generate the dimensional axes of the virtual social network. A grid cell associated with the host node may be selected 210 with which to compare attribute values with the search query. The attribute values for the search query may be compared 215 with the attribute values of the data objects of the selected grid cell (the “attribute values of the grid cell”). The attribute values for the search query may also be compared 220 with the attribute values of each acquaintance of the selected grid cell.

A determination of the closest matching grid cell may then be performed 225. In an embodiment, closeness may be based upon the difference between the attribute values of the search query and the attribute values of the grid cell as measured by any distance-measuring algorithm known to those of ordinary skill in the art. If the attribute values of the search query most closely match the attribute values of an acquaintance grid cell, the search query may be forwarded 230 to the grid cell. The above comparison steps 215, 220 may then be performed with the acquaintance as the newly selected grid cell. If the attribute values of the search query most closely match the attribute values of the selected grid cell, the query point is reached. In an embodiment, data objects associated with the query point may be returned 235 as part of the query result. In an embodiment, data objects associated with one or more acquaintances of the query point may also be returned 235 as part of the query result. In an embodiment, other data objects may also be returned 235 as part of the query result. In an embodiment using a typical distance-measuring algorithm to determine closeness, a query may be resolved in O(log²N) attribute value comparisons for a network of size N.

In an embodiment, a virtual social network may provide a unified architecture for locating and sharing distributed services, including services that differ substantially with respect to the information, computing and storage resources, and devices used to perform the services. One exemplary service may include personalized content delivery. Personalized content delivery may include an automatic adjustment of information content, structure and presentation tailored to a particular user. If users with similar profiles are interested in similar information content (or even structure and presentation), a network may harness this locality to provide personalized content. User profile information for each of a plurality of users may be mapped to peers in a network, where users with similar profiles may be clustered together. In order to determine content in which a particular user may be interested, grid cells close to the particular user's profile may be identified, and content in which users having similar profiles are interested may be retrieved. After particular content has been determined, a user's particular preferences with respect to information structure and presentation may be combined to achieve personalized content delivery.

In an embodiment, a network may provide distributed service locating. Presently, computing services are rapidly becoming ubiquitous. However, locating a particular service of interest, such as printing, faxing, and the like, that matches, for example, a user's specified preferences, such as distance, price, speed, and the like, amongst a large number of devices may be difficult to perform. In an embodiment, a virtual social network may be used to locate an acceptable service efficiently. In an embodiment, each device may be mapped to a peer in the network according to the device's service attributes, such as geographical location, price, speed, quality and the like. As such, locating an acceptable service may result in the transformation of a service request into a query that can be resolved in a small number of steps within the network.

In an embodiment, a network may provide automated device maintenance. As the number of devices within a network grows, the devices become more complex and/or the geographical separation of the devices becomes more distant, the effectiveness of centralized administration of such devices may decrease. In response, maintenance responsibility may be dedicated to the devices themselves. In an embodiment, as devices become more autonomous, the devices may be treated as peers in a network. As such, maintenance data objects on each device may collaborate via an exemplary virtual social network regarding a variety of aspects ranging from device configuration, diagnosis and repair to resource management as part of an automated device maintenance system.

In an embodiment, a network may be used to perform distributed knowledge discovery and data mining functions. In large networks, devices may generate large amounts of information continuously on an aggregate basis. Accordingly, it may become infeasible to send all generated information to a centralized server for storage and processing. As such, it may be necessary to develop distributed knowledge discovery and data mining techniques that can be performed in a distributed network. A network may assign peers that conduct traditional data mining techniques locally. Each peer may then communicate the local result with other peers, such as its acquaintances. Using such local communication, the local results may be expected to converge to a consistent global state.

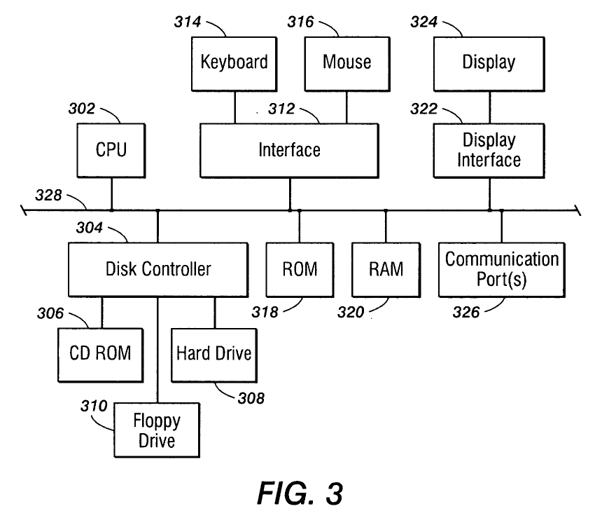

FIG. 3 is a block diagram of exemplary internal hardware that may be used to contain or implement the program instructions for a host node device according to an embodiment. Referring to FIG. 3, a bus 328 may serve as a main information highway interconnecting the other illustrated components of the hardware. CPU 302 is the central processing unit of the system, performing calculations and logic operations required to execute a program. Read only memory (ROM) 318 and random access memory (RAM) 320 constitute exemplary memory devices.

A disk controller 304 interfaces with one or more optional disk drives to the system bus 328. These disk drives may be external or internal floppy disk drives such as 310, CD ROM drives 306, or external or internal hard drives 308. As indicated previously, these various disk drives and disk controllers are optional devices.

Program instructions may be stored in the ROM 318 and/or the RAM 320. Optionally, program instructions may be stored on a processor-readable medium or carrier such as a floppy disk or a digital disk or other recording medium, a communications signal or a carrier wave.

An optional display interface 322 may permit information from the bus 328 to be displayed on the display 324 in audio, graphic or alphanumeric format. Communication with external devices may optionally occur using various communication ports 326. An exemplary communication port 326 may be attached to a communications network, such as the Internet or an intranet.

In addition to computer-type components and their equivalents, the hardware may also include an interface 312 which allows for receipt of data from input devices such as a keyboard 314 or other input device 316 such as a remote control, pointer and/or joystick.

A multiprocessor system may optionally be used to perform one, some or all of the operations described herein. Likewise, an embedded system may optionally be used to perform one, some or all of the operations described herein.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of managing distributed content, the method comprising:
receiving a plurality of data objects at a plurality of host nodes;
for each data object, assigning an attribute value for each of one or more attributes corresponding to the data object;
determining a network overlay based on the attribute values assigned to the plurality of data objects, wherein the network overlay comprises a plurality of grid cells;
generating one or more acquaintance links, wherein each acquaintance link represents a logical connection between two grid cells; and
assigning each data object to a grid cell based on at least one attribute value for the data object.

2. The method of claim 1 wherein generating one or more acquaintance links comprises generating a acquaintance link between a first grid cell and a second grid cell, wherein only one attribute value of a first data object in the first grid cell and a second data object in the second grid cell differ.

3. The method of claim I wherein generating one or more links comprises:
determining whether only one attribute value for a first data object in a first grid cell and the attribute values for a second data object in a second grid cell differ; and
if so, generating an acquaintance link between the first grid cell and the second grid cell with probability one divided by the difference between the differing attribute value of the first data object and the differing attribute value of the second data object.

4. The method of claim I wherein each grid cell comprises one data object.

5. The method of claim 1, further comprising:
adding a new data object to a host node;
assigning one or more attribute values for each of one or more attributes corresponding to the new data object;
assigning the new data object to a first grid cell based on the one or more attribute values; and
if a number of data objects in the first grid cell exceeds a threshold, partitioning the first grid cell into one or more second grid cells, wherein a second grid cell comprises one or more data objects contained within the first grid cell prior to partitioning the first grid cell.

6. The method of claim 5, further comprising:
generating one or more new acquaintance links for each second grid cell.

7. The method of claim 5, further comprising:
removing one or more acquaintance links associated with the first grid cell.

8. The method of claim 1 wherein the one or more attributes comprise one or more of the following:
a type;
a content description;
a size;
a creation time;
a last updated time;
user profile information;
a device service attribute;
a geographical location;
a price;
a speed;
a quality measure; and
a device configuration.

9. A method of performing a search query in a network, the method comprising:
receiving a search query at a first host node in a network, wherein the network comprises one or more host nodes, one or more grid cells and one or more acquaintance links, wherein each host node comprises one or more data objects, wherein each data object comprises one or more attributes each having an attribute value, wherein each grid cell contains one or more data objects having similar attribute values, wherein the one or more grid cells are organized based on the attribute values of the corresponding data objects, wherein each acquaintance link logically connects two grid cells having only one differing attribute value;
determining one or more attribute values for the search query;
selecting a grid cell associated with a data object on the first host node;
comparing the attribute values for the search query with the attribute values for the data objects within the selected grid cell;
if the attribute values for the search query do not substantially match the attribute values for the data objects within the selected grid cell, selecting a new grid cell logically connected to the selected grid cell by an acquaintance link;
repeating the comparing and selecting steps until the attribute values for the search query substantially match the attribute values for the data objects within the selected grid cell; and
returning one or more data objects as a search result.

10. The method of claim 9 wherein selecting a new grid cell comprises:
for each acquaintance link associated with a selected grid cell:
determining the attribute values for the data objects of the grid cell logically connected to the selected grid cell by the acquaintance link, and
selecting the grid cell having the data objects with the attribute values that most closely match the attribute values of the search query as the new grid cell.

11. The method of claim 9 wherein the search query substantially matches the selected grid cell when the attribute values of the data objects associated with the selected grid cell more closely match the attribute values of the search query than the attribute values of the data objects of any other grid cell logically connected to the selected grid cell by an acquaintance link match the attribute values of the search query.

12. The method of claim 9 wherein returning one or more data objects as a search result comprises returning the one or more data objects associated with the selected grid cell.

13. The method of claim 9 wherein returning one or more data objects as a search result comprises returning one or more data objects associated with grid cells logically connected to the selected grid cell by an acquaintance link.

14. The method of claim 9 wherein the one or more attributes comprise one or more of the following:
a type;
a content description;
a size;
a creation time;
a last updated time;
user profile information;
a device service attribute;
a geographical location;
a price;
a speed;
a quality measure; and
a device configuration.

15. A system for managing distributed content, the system comprising:
a plurality of host nodes, wherein each host node comprises:
a processor,
a processor-readable storage medium, and
a communication link,
wherein the processor-readable storage medium contains one or more programming instructions for performing a method of managing distributed content, the method comprising:
storing a first plurality of data objects,
for each data object, assigning an attribute value for each of one or more attributes corresponding to the data object,
receiving attribute values for a second plurality of data objects stored at one or more remote host nodes,
determining, via the processor, a network overlay based on the attribute values assigned to the first plurality of data objects and the second plurality of data objects, wherein the network overlay comprises a plurality of grid cells,
generating one or more acquaintance links, wherein each acquaintance link represents a logical connection between two grid cells via at least one communication link, and
assigning each data object to a grid cell based on at least one attribute value for the data object.

16. The system of claim 15 wherein the attributes of one or more data objects pertain to one or more of the following:
a file type;
a content description;
a file size;
a creation time;
a last updated time;
user profile information;
a device service attribute;
a geographical location;
a price;
a speed;
a quality measure; and
a device configuration.
